(19) United States
(12) Patent Application Publication
(10) Pub. No.: US 2025/0333621 A1
(43) Pub. Date: Oct. 30, 2025

(54) RESIN COMPOSITION AND INSULATED WIRE

(71) Applicants: SUMITOMO ELECTRIC INDUSTRIES, LTD., Osaka (JP); SUMITOMO ELECTRIC WINTEC, INC., Shiga (JP)

(72) Inventors: Hideaki SAITO, Osaka (JP); Masaaki YAMAUCHI, Osaka (JP); Hirotsugu MOCHIDA, Shiga (JP); Yunlong CUI, Shiga (JP); Kengo YOSHIDA, Shiga (JP)

(73) Assignees: SUMITOMO ELECTRIC INDUSTRIES, LTD., Osaka (JP); SUMITOMO ELECTRIC WINTEC, INC., Shiga (JP)

(21) Appl. No.: 18/579,778

(22) PCT Filed: Jul. 12, 2022
(86) PCT No.: PCT/JP2022/027474

§ 371 Date: Jan. 16, 2024

(30) Foreign Application Priority Data
Oct. 5, 2021 (JP) 2021-164106

(51) Int. Cl. C09D 179/08; C08G 73/10; H01B 3/30

(52) U.S. Cl. CPC C09D 179/08; C08G 73/1042; C08G 73/1071; H01B 3/306

(57) ABSTRACT

A resin composition according to one aspect contains: a polyimide precursor which is the reaction product of an aromatic tetracarboxylic dianhydride and an aromatic diamine; an organic solvent; and water. The resin composition has a water content of less than 0.5 mass %.

### TECHNICAL FIELD

The present disclosure relates to a resin composition and an insulated wire.

This application claims priority based on Japanese Patent Application No. 2021-164106 filed on Oct. 5, 2021, and the entire contents of the Japanese patent application are incorporated herein by reference.

### BACKGROUND ART

PTL 1 describes a resin composition containing a polyamic acid having a specific molecular structure and a solvent as a resin composition used for forming an insulating layer of an insulated wire.

### CITATION LIST

### Patent Literature

PTL 1: WO 2020/255360

### SUMMARY OF INVENTION

A resin composition according to an aspect of the present disclosure includes a polyimide precursor that is a reaction product of an aromatic tetracarboxylic dianhydride and an aromatic diamine, an organic solvent, and water. A water content is less than 0.5 mass %.

### BRIEF DESCRIPTION OF THE DRAWINGS

FIG. 1 is a schematic cross-sectional view of an insulated wire according to an embodiment of the present disclosure.

### DETAILED DESCRIPTION

### Problems to be Solved by Present Disclosure

As a method of forming an insulating layer of an insulated wire by polyimide, for example, there is a method including a coating step of coating a resin composition (resin varnish) containing a polyimide precursor (polyamic acid) and a solvent on the outer peripheral of a conductor, and a heating step of heating the obtained covering film, and in the heating step, the polyimide precursor is imidized to form polyimide. In the above method, only a relatively thin coating film can be formed by one coating step and heating step, and therefore, a coating film having a desired thickness is usually formed by repeating the coating step and the heating step. In order to increase the production efficiency of insulated wires by increasing the thickness of the coating film formed in one coating step and heating step, the concentration of the resin varnish is increased.

When the concentration of the resin varnish is increased, the viscosity of the resin varnish increases, and thus the coatability of the resin varnish in the coating step may be impaired. Therefore, a resin varnish that achieves both high concentration and coatability is required, and various studies have been conducted.

The present inventors have discovered during the progress of the studies that the viscosity of a resin varnish changes with time when the resin varnish having a high concentration is stored, and therefore, a resin varnish in which the change in viscosity with time is suppressed (hereinafter, also referred to as “excellent storage stability”) is required.

The present disclosure has been made in view of the above circumstances, and an object of the present disclosure is to provide a resin composition having excellent storage stability.

### Advantageous Effects of Present Disclosure

The resin composition according to an aspect of the present disclosure has excellent storage stability.

### DESCRIPTION OF EMBODIMENTS OF PRESENT DISCLOSURE

First, embodiments of the present disclosure will be listed and described.

According to an aspect of the present disclosure, a resin composition includes, a polyimide precursor that is a reaction product of an aromatic tetracarboxylic dianhydride and an aromatic diamine, an organic solvent, and water. A water content is less than 0.5 mass %.

The resin composition can improve storage stability by setting the water content to less than the upper limit. “Water content” means the content of water in the resin composition.

An imidization rate of the polyimide precursor is preferable to be 5% to 25%. In this case, the storage stability of the resin composition can be further improved. The term “imidization rate” means the ratio of the number of imide ring structures to the total number of amic acid structures and imide ring structures in the polyamic acid. Some of the imide ring structures may be isoimide ring structures.

The aromatic tetracarboxylic dianhydride preferably includes pyromellitic dianhydride. In this case, a polyimide coating film having both favorable heat resistance and toughness can be formed.

The aromatic diamine preferably includes 4,4′-diaminodiphenyl ether. In this case, a polyimide coating film having both favorable heat resistance and toughness can be formed.

A concentration of the polyimide precursor is preferable to be 25 mass % or more. In this case, the number of times of repeated coating can be reduced when the insulating layer of the insulated wire is formed, which contributes to improvement in manufacturing efficiency.

An insulated wire according to another aspect of the present disclosure includes a conductor, and an insulating layer covering the conductor. The insulating layer is formed of the resin composition according to the aspect of the present disclosure described above.

The insulated wire has an insulating layer formed of the resin composition described above, and therefore has excellent coating film uniformity, heat resistance, and toughness.

### Details of Embodiments of Present Disclosure

Hereinafter, a resin composition and an insulated wire according to an aspect of the present disclosure will be described in detail.

### <Resin Composition>

The resin composition includes a polyimide precursor that is a reaction product of an aromatic tetracarboxylic dianhydride and an aromatic diamine, an organic solvent, and water.

The water content of the resin composition is less than 0.5 mass %. By setting the water content to be less than the upper limit, the storage stability of the resin composition can be improved. The water content of the resin composition can be calculated by dividing the amounts of water measured by the Karl Fischer method in accordance with JIS-K-0113 (2005) by the total mass of the resin composition.

The lower limit of the water content is preferably 0.05 mass %, and more preferably 0.15 mass %. By setting the water content to the lower limit or higher, the storage stability of the resin composition can be further improved.

Hereinafter, each component contained in the resin composition will be described.

### (Polyimide Precursor)

The polyimide precursor is a reaction product obtained by a polymerization condensation reaction of aromatic tetracarboxylic dianhydride and aromatic diamine.

The molar ratio of the aromatic tetracarboxylic dianhydride to the aromatic diamine (aromatic tetracarboxylic dianhydride/aromatic diamine) used as the raw materials of the polyimide precursor may be, for example, 95/105 to 105/95, more preferably 97/103 to 103/97, and still more preferably 99/101 to 101/99, from the viewpoint of the ease of synthesis of the polyimide precursor.

The aromatic tetracarboxylic dianhydride is preferable to include pyromellitic dianhydride (PMDA). In addition, the aromatic tetracarboxylic dianhydride may contain an aromatic tetracarboxylic dianhydride other than PMDA.

Other than PMDA, examples of aromatic tetracarboxylic dianhydrides include 3,3′,4,4′-biphenyltetracarboxylic dianhydride (s-BPDA), 2,3,3′,4′-biphenyltetracarboxylic dianhydride (a-BPDA), 2,2′,3,3′-biphenyltetracarboxylic dianhydride (i-BPDA), 3,3′,4,4′-benzophenonetetracarboxylic dianhydride, 4,4′-oxydiphthalic dianhydride, 2,2′,3,3′-benzophenonetetracarboxylic dianhydride, 2,2′-bis(3,4-dicarboxyphenyl)propane dianhydride, 2,2′-bis(2,3-dicarboxyphenyl)propane dianhydride, 1,1′-bis(3,4-dicarboxyphenyl)ethane dianhydride, 1,1′-bis(2,3-dicarboxyphenyl)ethane dianhydride, bis(3,4-dicarboxyphenyl)methane dianhydride, bis(2,3-dicarboxyphenyl)methane dianhydride, bis(3,4-dicarboxyphenyl)sulfone dianhydride, bis(3,4-dicarboxyphenyl)ether dianhydride, 1,2,5,6-naphthalenetetracarboxylic dianhydride, 2,3,6,7-naphthalenetetracarboxylic dianhydride, or the like. Among these, s-BPDA is preferable from the viewpoint of imparting heat resistance, toughness, and hydrolysis resistance. The aromatic tetracarboxylic dianhydrides other than PMDA may be used alone or in combination of two or more.

The lower limit of the amount of PMDA relative to 100 mol % of the aromatic tetracarboxylic dianhydride is 10 mol %, preferably 15 mol %, and more preferably 20 mol %. By setting the content of PMDA to the lower limit or higher, favorable heat resistance can be imparted at low cost. The upper limit of the content of the PMDA is, for example, 100 mol %.

The aromatic diamine may include 4,4′-diaminodiphenyl ether (4,4′-ODA). The aromatic diamine may also include an aromatic diamine other than 4,4′-ODA.

Examples of aromatic diamines other than 4,4′-ODA include 3,4′-diaminodiphenyl ether (3,4′-ODA), 3,3′-diaminodiphenyl ether (3,3′-ODA), 2,4′-diaminodiphenyl ether (2,4′-ODA), 2,2′-diaminodiphenyl ether (2,2′-ODA), and other diaminodiphenyl ethers (ODA). Additionally, it includes 2,2-bis-[4-(4-aminophenoxy)phenyl]propane (BAPP), 4,4′-diaminodiphenyl methane, 3,4′-diaminodiphenyl methane, 3,3′-diaminodiphenyl methane, 2,4′-diaminodiphenyl methane, 2,2′-diaminodiphenyl methane, 4,4′-diaminodiphenyl sulfone, 3,4′-diaminodiphenyl sulfone, 3,3′-diaminodiphenyl sulfone, 2,4′-diaminodiphenyl sulfone, 2,2′-diaminodiphenyl sulfone, 4,4′-diaminodiphenyl sulfide, 3,4′-diaminodiphenyl sulfide, 3,3′-diaminodiphenyl sulfide, 2,4′-diaminodiphenyl sulfide, 2,2′-diaminodiphenyl sulfide, paraphenylenediamine, metaphenylenediamine, p-xylylenediamine, m-xylylenediamine, 2,2′-dimethyl-4,4′-diaminobiphenyl, 1,5-diaminonaphthalene, 4,4′-benzophenonediamine, 3,3′-dimethyl-4,4′-diaminodiphenyl methane, and 3,3′,5,5′-tetramethyl-4,4′-diaminodiphenyl methane, or the like. These aromatic diamines may be used alone or in combination of two or more.

The lower limit of the content of 4,4′-ODA relative to 100 mol % of the aromatic diamine is preferably 50 mol %, more preferably 70 mol %, and still more preferably 90 mol %. When the content of 4,4′-ODA is equal to or higher than the lower limit, favorable heat resistance and toughness can be imparted at low cost. The content of ODA is particularly preferably 100 mol %.

In the polyimide precursor, some or all of the carboxylic anhydride groups at the molecular terminals are preferably ring-opened by a hydrolysis reaction with water contained in the resin composition. That is, in the polyimide precursor, some or all of the carboxylic anhydride groups at the molecular terminals are preferably dicarboxylic acid groups. In this case, the storage stability of the resin composition can be further improved.

The lower limit of the imidization rate of the polyimide precursor is preferably 5%, more preferably 6%, and still more preferably 8%. The upper limit of the imidization rate is preferably 25%, and more preferably 20%. By setting the imidization rate within the above range, the storage stability of the resin composition can be further improved.

The lower limit of the concentration of the polyimide precursor in the resin composition is preferably 25 mass %, and more preferably 27 mass %. The upper limit of the concentration is preferably 40 mass %, and more preferably 35 mass %. When the concentration is set to be equal to or more than the lower limit, it is possible to reduce the amount of the resin composition required in the entire manufacturing process in order to obtain an insulating layer having a desired thickness when the insulating layer is formed using the resin composition, and to reduce the number of times of the coating process and the heating process. When the concentration is equal to or less than the upper limit, the viscosity of the resin composition can be appropriately adjusted while maintaining favorable film properties, and the coatability can be improved.

The lower limit of the weight average molecular weight of the polyimide precursor is preferably 15,000, and more preferably 16,000. The upper limit of the weight average molecular weight of the polyimide precursor is preferably 100,000, and more preferably 50,000. When the weight average molecular weight is less than the lower limit, the elongation of the coating film may be insufficient when forming the insulating layer of the insulated wire. On the other hand, when the weight-average molecular weight of the polyimide precursor exceeds the upper limit, the viscosity of the resin composition may be excessively increased. The “weight-average molecular weight” of the polyimide precursor is a value measured by gel permeation chromatography in terms of polystyrene in accordance with JIS-K7252-1 (2008) “Plastics-Determination of molecular weight and molecular weight distribution of polymers by size exclusion chromatography-part 1: General rules”.

### (Method of Synthesizing Polyimide Precursor)

The polyimide precursor may be obtained by a polymerization condensation reaction of the aromatic tetracarboxylic dianhydride and the aromatic diamine described above. The polymerization condensation reaction may be carried out in the same manner as in the synthesis of a conventional polyimide precursor. As a specific method of the polymerization condensation reaction includes, for example, a method of mixing aromatic tetracarboxylic dianhydride and aromatic diamine in an organic solvent and heating the mixed solution. By this method, the aromatic tetracarboxylic dianhydride and the aromatic diamine are polymerized, and a solution in which the polyimide precursor is dissolved in the organic solvent can be obtained. The polymerization degree can be controlled without using a terminal blocking agent or the like by carrying out the reaction in the presence of an appropriate amount of water in the reaction system.

The polymerization conditions may be appropriately set depending on the raw materials used, and the like. For example, the polymerization temperature may be 10° C. to 100° C., and the reaction time may be 0.5 hours to 24 hours.

Examples of the organic solvent used in the polymerization condensation reaction include similar organic solvents as those contained in the resin composition described later.

### (Organic Solvent)

As the organic solvent, for example, an aprotic polar organic solvent such as N-methyl-2-pyrrolidone (NMP), N, N-dimethylacetamide (DMAc), N, N-dimethylformamide, dimethyl sulfoxide, or γ-butyrolactone can be used. These organic solvents may be used alone or in combination of two or more. The term “aprotic polar organic solvent” refers to a polar organic solvent that does not have a group that releases a proton.

The amount of the organic solvent used is not particularly limited as long as the aromatic tetracarboxylic dianhydride and the aromatic diamine can be uniformly dissolved and dispersed in the organic solvent. However, when the amount of the organic solvent used is too large, a large amount of the solvent needs to be volatilized when the insulating layer of the insulated wire is formed, and thus it may take time to form the insulating layer. Therefore, the amount of the organic solvent used can be, for example, 100 parts by mass to 1,000 parts by mass with respect to 100 parts by mass of the total of the aromatic tetracarboxylic dianhydride and the aromatic diamine.

### (Water)

The water contained in the resin composition may be water present in the reaction system when the polyimide precursor is synthesized, water added when the resin composition is prepared, or water generated by the dehydration ring-closure reaction of the amic acid structure in the polyimide precursor.

### <Insulated Wire>

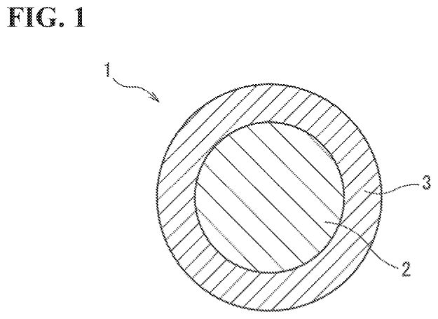

The insulated wire includes a conductor and an insulating layer covering the conductor. FIG. 1 is a schematic cross-sectional view of an insulated wire according to an embodiment of the present disclosure. As shown in FIG. 1, an insulated wire 1 includes a conductor 2 and an insulating layer 3 covering conductor 2.

### (Conductor)

Conductor 2 is usually made of a metal as a main component. The metals are not particularly limited, but are preferably Cu, Cu alloys, aluminum, or aluminum alloys. By using the above-mentioned metal for conductor 2, an insulated wire having favorable processability, conductivity, and the like can be obtained. Conductor 2 may contain other components such as known additives in addition to the metal as the main component.

The cross-sectional shape of conductor 2 is not particularly limited, and various shapes such as a circle, a square, and a rectangle can be adopted. The size of the cross section of conductor 2 is not particularly limited, and the diameters (short side widths) can be, for example, 0.2 mm to 8.0 mm.

### (Insulating Layer)

Insulating layer 3 is laminated on the circumferential surface of conductor 2 so as to cover conductor 2. Insulating layer 3 is a layer formed of the resin composition described above. Insulating layer 3 may directly cover conductor 2 or indirectly cover conductor 2 with another layer interposed therebetween. In the case of indirect coating, for example, a multilayered structure in which the coating layer of conductor 2 includes a layer other than insulating layer 3 may be used.

The average thickness of insulating layer 3 is not particularly limited, and is usually 2 μm to 200 μm.

Insulated wire 1 may further include another layer laminated on the outer peripheral of insulating layer 3. Examples of the other layer include a surface lubricating layer.

### (Method of Manufacturing Insulated Wire)

The insulated wire can be produced by a method including, for example, a step of coating the resin composition to the outer peripheral of a conductor (hereinafter, also referred to as “coating step”) and a step of heating the resin composition coated to the conductor (hereinafter, also referred to as “heating step”).

In the coating step, the resin composition is applied to the outer peripheral side of the conductor. As a method of coating the resin composition to the outer peripheral of the conductor, for example, a method using a coating apparatus including a liquid composition tank storing the resin composition and a coating die can be included. According to this coating apparatus, the resin composition adheres to the outer peripheral of the conductor by inserting the conductor into the liquid composition tank, and then the resin composition is coated to a uniform thickness by passing through the coating die.

In the heating step, the resin composition applied to the conductor in the coating step is heated. By this heating, the solvent in the resin composition is volatilized, and the polyimide precursor is cured to form polyimide. Thus, an insulating layer having excellent electrical, mechanical and thermal properties can be obtained.

The apparatus used in the heating step is not particularly limited, and for example, a cylindrical baking furnace which is long in the running direction of the conductor can be used. The heating method is not particularly limited, and the heating can be performed by a conventionally known method such as hot air heating, infrared heating, or high-frequency heating.

The heating temperature can be set to, for example, 300° C. to 800° C., and the heating time can be set to 5 seconds to 1 minute. When the heating temperature or the heating time is less than the lower limit, the volatilization of the solvent and the formation of the insulating layer become insufficient, and the appearance, electrical characteristics, mechanical characteristics, thermal characteristics, and the like of the insulated wire may be deteriorated. To the contrary, when the heating temperature is higher than the upper limit, foaming of the insulating layer or a decrease in mechanical properties may be caused by excessively rapid heating. In addition, when the heating time exceeds the upper limit, the productivity of the insulated wire may be reduced.

The coating step and the heating step are usually repeated a plurality of times. In this way, the thickness of the insulating layer can be increased. At this time, the hole diameter of the coating die is appropriately adjusted in accordance with the number of repetitions.

### Example

The present invention will be described in more detail with reference to the following examples, but the present invention is not limited to these examples.

### <Preparation of Resin Composition>

The abbreviations of the components used for the preparation of the resin composition are shown below.
ODA: 4,4′-Diaminodiphenyl ether
PMDA: Pyromellitic dianhydride
BPDA: 3,3′,4,4′-Biphenyl tetracarboxylic dianhydride
NMP: N-Methyl-2-pyrrolidone
DMAc: N,N-Dimethylacetamide

### [Preparation Example 1] Preparation of Resin Composition No. 1

After the total amount of PMDA was dispersed in NMP, 7 mol % of water was added to the amount of PMDA charged, and 1 h stirring was performed at 30° C. Thereafter, ODA was added to the mixture so as to have a molar ratio shown in Table 1 below, and the mixture was stirred under a nitrogen atmosphere. Thereafter, the mixture was stirred and reacted until the viscosity was stabilized, thereby preparing a resin composition No. 1.

### [Preparation Examples 2 to 8] Preparation of Resin Compositions Nos. 2 to 8

Resin compositions Nos. 2 to 8 were prepared in the same manner as in Preparation Example 1 except that the types and amounts of the components used were as shown in Table 1 below. The concentrations of the polyimide precursors in the obtained resin compositions Nos. 2 to 8 are also shown in Table 1 below.

### <Physical Properties of Resin Composition>

The concentrations of polyimide precursors, water contents, and imidization rates of the resin compositions Nos. 1 to 8 prepared above were measured by the following methods. The results are shown in Table 1 below.

### [Concentration of Polyimide Precursor]

The resin composition was dried at 250° C. for 2 hours, and a mass WO before drying and a mass WI after drying were measured, and the concentration (unit: mass %) was calculated by WI/WO×100.

### [Water Content]

The water content was calculated by dividing the amounts of water measured by the Karl Fischer method in accordance with JIS-K-0113 (2005) by the total mass of the resin composition.

### [Imidization Rate]

The imidization rate was measured by ¹H-NMR. The resin composition was weighed out in 50 mg in a vial, and DMSO-d6 were added in 1 mL to dissolve the resin composition. After confirming the dissolution, the sample liquid 0.5 mL was put into an NMR sample tube. From the analyzed chart, the number of amide groups determined from the number of protons derived from amide protons was calculated based on the integral value of 1H derived from the benzene ring of the dianhydride, and the imidization rate was calculated assuming that the remainder was imidized.

### <Evaluation of Storage Stability>

The viscosities (initial viscosities η₀) of the resin compositions Nos. 1 to 8 prepared above at 30° C. at the time of preparation were measured using a B-type viscometer. Thereafter, the resin compositions were stored in a sealed state at 5° C. for 30 days, and the viscosities at 30° C. after 30 days (viscosity after storage η₁) were measured. The ratios η₁/η₀ of the viscosities after storage qt to the initial viscosities η₀ were calculated. The case where the ratio η₁/η₀ was 1.0 to 2.0 was evaluated as favorable storage stability. The results are shown in Table 1 below.

In Table 1, “-” indicates that the corresponding component was not used.

TABLE 1

| Resin composition | | No. 1 | No. 2 | No. 3 | No. 4 | No. 5 | No. 6 | No. 7 | No. 8 |
|---|---|---|---|---|---|---|---|---|---|
| Acid dianhydride | PMDA (Molar ratio) | 100 | 100 | 100 | 100 | 30 | 20 | 100 | 100 |
| | BPDA (Molar ratio) | — | — | — | — | 70 | 80 | — | — |
| Aromatic diamine | ODA (Molar ratio) | 100 | 100 | 100 | 100 | 100 | 100 | 100 | 100 |
| Organic solvents | NMP (Mass ratio) | 100 | 10 | 20 | 30 | 100 | 100 | 100 | 100 |
| | DMAc (Mass ratio) | — | 90 | 80 | 70 | — | — | — | — |
| Physical Properties | Concentration (mass %) | 30 | 28 | 28 | 28 | 30 | 30 | 30 | 30 |
| | Water content (mass %) | 0.15 | 0.48 | 0.35 | 0.28 | 0.36 | 0.4 | 0.05 | 0.6 |
| | Imidization rate (%) | 9 | 11 | 10 | 8.6 | 13 | 18 | 8 | 15 |
| Storage Stability | η₁/η₀ | 1.6 | 1.9 | 1.8 | 1.7 | 1.3 | 1.2 | 2.0 | 2.4 |

As is clear from Table 1, the resin compositions No. 1 to No. 7 had better storage stability than the resin composition No. 8.

### REFERENCE SIGNS LIST

1 insulated wire
2 conductor
3 insulating layer

1. A resin composition comprising:
a polyimide precursor that is a reaction product of an aromatic tetracarboxylic dianhydride and an aromatic diamine;
an organic solvent; and
water,
wherein a water content is less than 0.5 mass %.

2. The resin composition according to claim 1, wherein an imidization rate of the polyimide precursor is 5% to 25%.

3. The resin composition according to claim 1, wherein the aromatic tetracarboxylic dianhydride includes pyromellitic dianhydride.

4. The resin composition according to claim 1, wherein the aromatic diamine includes 4,4′-diaminodiphenyl ether.

5. The resin composition according to claim 1, wherein a concentration of the polyimide precursor is 25 mass % or more.

6. (canceled)

7. The resin composition according to claim 2, wherein the aromatic tetracarboxylic dianhydride includes pyromellitic dianhydride.

8. The resin composition according to claim 2, wherein the aromatic diamine includes 4,4′-diaminodiphenyl ether.

9. The resin composition according to claim 3, wherein the aromatic diamine includes 4,4′-diaminodiphenyl ether.

10. The resin composition according to claim 2, wherein a concentration of the polyimide precursor is 25 mass % or more.

11. The resin composition according to claim 3, wherein a concentration of the polyimide precursor is 25 mass % or more.

12. The resin composition according to claim 4, wherein a concentration of the polyimide precursor is 25 mass % or more.

13. An insulated wire comprising:
a conductor; and
an insulating layer covering the conductor,
wherein the insulating layer is formed of the resin composition according to claim 1.
